(19) United States
(12) Patent Application Publication
(10) Pub. No.: US 2015/0353876 A1
(43) Pub. Date: Dec. 10, 2015

(54) FRUIT-BASED FOOD AND BEVERAGE CONTAINING COMPONENTS DERIVED FROM AMLA

(71) Applicant: MC FOOD SPECIALTIES INC., Tokyo (JP)

(72) Inventors: Atsushi KOYANAGI, Inashiki-gun (JP); Keishi HARA, Inashiki-gun (JP)

(21) Appl. No.: 14/377,735

(22) PCT Filed: Dec. 17, 2012
(86) PCT No.: PCT/JP2012/082631

§ 371 Date: Aug. 8, 2014

(30) Foreign Application Priority Data
Feb. 10, 2012 (JP) 2012-027637

(51) Int. Cl. C12G 3/06; A23L 1/22; A23L 2/04; A23L 1/212; A23L 1/222

(52) U.S. Cl. CPC C12G 3/06; A23L 1/212; A23L 1/222; A23L 2/04; A23L 1/22083; A23V 2002/00

(57) ABSTRACT

The present invention provides a fruit-based food and beverage having excellent richness and full bodiness, a method for enhancing richness and full bodiness of a fruit-based food and beverage without imparting astringent taste and bitter taste more than necessary, and a method for improving the quality of taste in a food and beverage.

[Means for Solving Problem]

The fruit-based food and beverage containing a component derived from amla of the present invention comprises at least one selected from a group consisting of amla fruit, amla fruit juice and amla fruit extract.

### CROSS-REFERENCE TO RELATED APPLICATION

The present patent application claims priority of Japanese Patent Application No. 2012-27637 filed on Feb. 10, 2012, the entire disclosure of which is incorporated herein by reference.

### BACKGROUND OF THE INVENTION

1. Field of the Invention

The present invention relates to a fruit-based food and beverage containing components derived from amla, and a method for improving the quality of taste in the fruit-based food and beverage.

2. Background Art

Among the flavor of a food and beverage, “richness and full bodiness (richness)” is also called as “thickness or fullness” in the case of fruit liquor such as wine for example, and is an important element leading to satisfaction at the time of taking a meal. Thus, various methods for providing the food and beverage with richness and full bodiness have been performed. For example, a method is known in which polyphenol such as saponin, tannin, limonin, catechin, caffeine and the like is added to wine. However, polyphenol is generally known to be a component having astringent taste and bitter taste which deteriorate the flavor of the food and beverage.

For example, Japanese Patent Application Laid-Open No. 2006-238829 (Patent Document 1) discloses a method in which vicenin-2, a type of polyphenol, is added to a non-fruit juice beverage or a fruit juice beverage containing a low amount of fruit juice to impart the richness, voluminous feeling and rich feeling as if the resultant beverage is a fruit juice beverage containing a large amount of fruit juice. However, in this method, the astringent taste of vicenin-2 is conveyed to the food and beverage. Thus, it is not possible to avoid adding the astringent taste to the food and beverage for obtaining the effect described above.

In addition, Japanese Patent Application Laid-Open Publication No. 2005-204585 (Patent Document 2) discloses a low alcoholic beverage having a complex flavor obtained by adding fruit wine, and hop polyphenol or apple polyphenol to a low alcoholic beverage. However, the object for the improvement in the quality of taste shown in this document is only a low alcoholic beverage, such as chuhai or cocktail based on distilled liquor such as vodka, gin or the like. A fruit liquor is not disclosed in the patent document at all.

On the other hand, amla is a plant distributed from India to Malaysia region, and in southern China, and is used as a material of a pickles or a material of a sugared food called as murabba. As to amla, for example, Japanese Patent Application Laid-Open Publication No. 2006-335721 (Patent Document 3) discloses a composition for removing a shoulder pain and discloses that the composition contains amla fruit, amla fruit juice or amla fruit extract.

### PRIOR ART REFERENCES

### Patent Documents

[Patent Document 1] Japanese Patent Laid-Open Publication No. 2006-238829
[Patent Document 2] Japanese Patent Laid-Open Publication No. 2005-204585
[Patent Document 3] Japanese Patent Laid-Open Publication No. 2006-335721

### SUMMARY OF THE INVENTION

### Problems to be Solved by the Invention

The problems to be solved by the present invention is to provide a fruit-based food and beverage having excellent richness and full bodiness, a method for enhancing the richness and full bodiness of a fruit-based food and beverage without imparting astringent taste and bitter taste more than necessary, and a method for improving the quality of taste in a food and beverage.

### Means to Solve the Problems

The present inventors have recently found unexpectedly that, when a component derived from amla is added to a fruit-based food and beverage, it is possible to obtain a fruit-based food and beverage in which the quality of taste is improved, particularly, richness and full bodiness are enhanced. In addition, the present inventors have succeeded to impart only richness and full bodiness to a fruit-based food and beverage, without imparting astringent taste and bitter taste specific to a polyphenol more than necessary, by adding the component derived from amla. As for fruit liquor among the fruit-based food and beverage, for example grape wine, the present inventors have succeeded to produce a grape wine having excellent richness and full bodiness. Furthermore, the present inventors have succeeded to improve the quality of taste in a food and beverage by adding the fruit-based food and beverage to a different food and beverage. The present invention is based on these findings.

The present invention provides inventions described below.
(1) A fruit-based food and beverage containing a component derived from amla, which comprises at least one selected from a group consisting of amla fruit, amla fruit juice and amla fruit extract.
(2) A fruit-based food and beverage, comprising a polyphenol derived from amla fruit.
(3) The fruit-based food and beverage according to (1) or (2), comprising 300 to 5000 ppm of a polyphenol derived from amla fruit.
(4) The fruit-based food and beverage according to any one of (1) to (3), wherein the fruit used for the fruit-based food and beverage is a grape.
(5) A method for improving a quality of taste in a fruit-based food and beverage, comprising adding at least one selected from a group consisting of amla fruit, amla fruit juice and amla fruit extract to the fruit-based food and beverage.
(6) A method for improving a quality of taste in a fruit-based food and beverage, comprising adding a polyphenol derived from amla fruit to the fruit-based food and beverage.
(7) A food and beverage, comprising the fruit-based food and beverage according to any one of (1) to (4).
(8) A method for improving a quality of taste in a food and beverage, comprising adding at least one selected from a group consisting of amla fruit, amla fruit juice and amla fruit extract, and a fruit-based food and beverage to a different food and beverage.
(9) A method for improving a quality of taste in a food and beverage, comprising adding a polyphenol derived from amla fruit and a fruit-based food and beverage to a different food and beverage.

### Effect of the Invention

The present invention is able to provide a fruit-based food and beverage having excellent richness and full bodiness, a method for enhancing the richness and full bodiness of a fruit-based food and beverage without imparting astringent taste and bitter taste more than necessary, and a method for improving the quality of taste in a food and beverage.

### DETAILED DESCRIPTION OF THE INVENTION

The specific description of the invention is as follows.

Fruit-Based Food and Beverage Containing a Component Derived from Amla

According to an embodiment of the present invention, the fruit-based food and beverage containing a component derived from amla of the present invention comprises at least one selected from a group consisting of amla fruit, amla fruit juice and amla fruit extraction. In addition, according to another embodiment of the present invention, the present invention is a fruit-based food and beverage containing a polyphenol derived from amla fruit.

In the present description, the fruit-based food and beverage containing a component derived from amla means a fruit-based food and beverage that contains a component derived from amla. The component derived from amla means at least one selected from a group consisting of amla fruit, amla fruit juice and amla fruit extract, or means a polyphenol derived from amla fruit. The amla fruit, amla fruit juice and amla fruit extract preferably contain a polyphenol derived from amla fruit.

Amla is a sub tall deciduous tree (middle to low-height tree) belonging to Euphorbiaceae emblica, whose scientific name is Phyllanthus embilica, whose another name is Emblica officinalis Gaertn, whose English name is Emblicmyrobalan and whose Japanese name is Komikanso, Yukan, Indosuguri, Anmaroku or the like.

It is known that the fruit of amla contains a large amount of polyphenol, and that the fruit of amla is used in formulations for eye disease, anemia, shigellosis or the like.

The amla fruit means a fruit having a flesh born on a tree of amla. The amla fruit used in the present invention may be an unripe fruit, a ripe fruit, a dry fruit, fruit paste or the like.

The amla fruit juice used in the present invention can be obtained by squeezing the fruit of amla. The amla fruit juice may be in the form of a liquid or powder.

The amla fruit extract used in the present invention means extract selected from a flesh of amla, a pericarp of amla and a seed of amla. As the form of this extract, an extracted liquid, a diluted solution thereof, a concentrated solution thereof, an essence thereof, a crudely purified product thereof, a finely purified product thereof, a dry matter thereof, or dry powder thereof may be cited. The amla fruit extract can be obtained by extracting the whole of the fruit of amla, or a part of the fruit of amla (for example, flesh, pericarp, seed, fruit juice, or squeezed juice cake after the fruit juice is squeezed), preferably by extracting the amla fruit juice, and more preferably by extracting the powder form of the amla fruit juice.

The extraction operation is not limited specifically and various operations generally used in the food processing field can be used as the extraction operation, including for example, solvent extraction, air current extraction, the squeeze extraction or the like. It is possible to further carry out a treatment, such as adsorption, concentration, vacuum filtration, centrifugal separation or the like as necessary. In addition, an extract obtained once by an extraction operation may be subjected to a extraction operation again. The extraction operation can be appropriately selected by one of ordinary skill in the art, based on a portion or an amount of the amla fruit to be extracted.

Water, ethanol, or a mixed solvent having an arbitrary proportion of water and ethanol is preferable as an extracting solvent used for the solvent extraction. The ethanol concentration of the mixed solvent is preferably 1 to 99.9 volume percentage (vol. %), more preferably 2 to 60 vol. %, and further more preferably 5 to 30 vol %.

As an example of the extraction operation, a method can be cited in which a part of the fruit of amla is soaked and stirred in an extracting solvent at 0 to 50° C. for 1 minute to 24 hours and then the mixture is subjected to filtering or centrifugal separation. Conditions such as temperature and time during the extraction time, are not specifically limited, and can be arbitrarily selected and set by one of ordinary skill in the art, based on a portion or an amount of the fruit of amla.

The polyphenol derived from amla fruit used for the present invention may be isolated or purified from amla fruit, or may be a mixture containing a polyphenol derived from amla fruit. For example, amla fruit, amla fruit juice or amla fruit extraction can be cited as the mixture. The polyphenol derived from amla fruit, used in the present invention, can be provided as a form of amla fruit juice itself obtained by squeezing of the fruit of amla, or a form of diluted solution thereof or concentrated solution thereof. Furthermore, in the case that the amla fruit juice is powdery, the polyphenol derived from amla fruit used in the present invention can be provided as a form of a solution prepared by dissolving the powder in water, ethanol, or a mixed solution of water and ethanol. In that case, the concentration of polyphenol in the solution obtained can be adjusted by the amount of the solvent. The concentration of the polyphenol can be measured by the Folin-Denis method.

In the present description, the fruit-based food and beverage means a fruit-based beverage and a fruit-based food that contain the whole of a fruit itself, a part (for example, flesh, pericarp, fruit juice or the like) of a fruit itself, or a processed product thereof.

A fruit used for the fruit-based food and beverage is not specifically limited, and includes, for example, a grape, an apple, a citrus (for example, grapefruit or orange) or the like, and the grape is preferable.

In the present description, the fruit-based beverage means an alcoholic beverage and a non-alcoholic beverage (soft beverage) that contain the whole of a fruit itself, a part (for example, flesh, pericarp, fruit juice or the like) of a fruit itself, or a processed product thereof. Specifically, the fruit-based beverages used in the present invention are fruit liquor and fruit beverage.

In the present description, the fruit liquor means a beverage obtained by adding yeast to a raw material, which is fruit ground product or fruit juice, and by filtering the fermentation liquid that is obtained by fermentation and has an alcohol concentration of 1 to 20%, and a beverage in which a fruit is soaked in alcohol, such as shochu (alcohol concentration is 35%). The fruit liquor used in the present invention includes, for example, still wine of each fruit, sparkling wine (for example, Champagne, Cider or the like), alcohol fortified wine (for example, Sherry, Port Wine or the like), flavored wine (for example, Vermouth, Sangria or the like), and liquor in which a fruit is soaked in alcohol (plum wine, cassis liquor, citron liquor or the like). Grape wine and Cider are preferable for the fruit liquor, and the grape wine is more preferable.

In the present description, the fruit beverage means a beverage (non-alcoholic beverage) which uses a fruit as a raw material and has an alcohol concentration less than 1 vol. %. For example, concentrated fruit juice, fruit juice, fruit mix juice, fruit juice with pulp, fruit and vegetable mix juice, and a beverage containing fruit juice are cited as the fruit beverage. A wine taste beverage is also included. The fruit beverage used for the present invention is preferably a wine taste beverage, grape juice, grapefruit juice, orange juice or apple juice, and more preferably grape wine taste beverage, grape juice, grapefruit juice or orange juice, further more preferably grape wine taste beverage or grape juice. The fruit beverage may be a straight one, concentrated one, diluted one, or concentrated reduced (from-concentrate) one. The concentration of fruit beverage is not specifically limited, if a fruit beverage contains any amount of fruit. Thus, a 100% fruit juice is also used. Furthermore, the fruit beverage may be carbonated.

### Taste Quality Improvement

The fruit-based food and beverage containing a component derived from amla of the present invention is a fruit-based food and beverage whose quality of taste is improved to arbitrary desired quality of taste, by adding a component derived from amla to a fruit-based food and beverage. In other words, according to an embodiment of the present invention, the fruit-based food and beverage containing a component derived from amla of the present invention contains a component derived from amla as a taste quality improvement agent. The component derived from amla used for the present invention can be used as the taste quality improvement agent for the fruit-based food and beverage.

The “taste quality improvement effect” in the present description means to improve, reform or enhance an original flavor of a fruit-based food and beverage to which a component derived from amla is intended to be added, or means to reinforce the flavor to a desired level. The taste quality improvement means preferably to improve richness, full bodiness and thickness of the flavor in the fruit-based food and beverage, and more preferably to enhance richness and full bodiness of a fruit-based food and beverage, without imparting astringent taste, bitter taste, and harsh taste more than necessary. In addition, the “taste quality improvement effect” includes the taste quality improvement effect of a food and beverage obtained when a component derived from amla, together with a fruit-based food and beverage, are added to the food and beverage. The taste quality improvement effect is to preferably enhance richness and rich feeling of a food and beverage without imparting astringent taste and bitter taste more than necessary.

According to an embodiment of the present invention, there is provided a method for improving a quality of taste in a fruit-based food and beverage in which at least one selected from a group consisting of amla fruit, amla fruit juice and amla fruit extract is added to a fruit-based food and beverage. In addition, according to another embodiment of the present invention, there is provided a method for improving a quality of taste in a fruit-based beverage comprising adding a polyphenol derived from amla fruit to the fruit-based food and beverage.

The amount of a component derived from amla used for the present invention and added to a fruit-based food and beverage can be appropriately selected by one of ordinary skill in the art based on the kinds and properties of the fruit-based food and beverage. For example, in terms of attaining a desired effect of the taste quality improvement, the amount added to the fruit-based food and beverage is preferably 300 to 5000 ppm, more preferably 600 to 5000 ppm, further preferably 600 to 4000 ppm, furthermore preferably 700 to 3000 ppm, and particularly preferably 1400 to 3000 ppm, in terms of the concentration converted to that of a polyphenol derived from amla fruit. Higher concentrations of polyphenol derived from amla fruit tend to induce astringent taste and harsh taste. Alternatively, the amount added is 0.4 to 6.8 vol. %, preferably 0.8 to 5.4 vol. %, more preferably 0.9 to 4.1 vol. %, and furthermore preferably 1.8 to 4.1 vol. %, in terms of the concentration converted to that of the amla fruit extract (for example, the extract of the example 1 described below).

The fruit-based food and beverage containing a component derived from amla of the present invention may be directly taken as a fruit-based food and beverage, or as a diluted food and beverage. Specifically, in the case of fruit-based beverage containing a component derived from amla, it may be taken as a food and beverage prepared by dilution by water or other beverages (for example, soft beverage, carbonated beverage, fruit juice beverage, alcoholic beverage).

In addition, the fruit-based food and beverage containing a component derived from amla of the present invention may be added to a different food and beverage. For example, it may be used for seasoning to a raw material, as a base of a source, hidden flavor in boiled dishes, flavor given to a different food and beverage and the like. Namely, according to an embodiment of the present invention, there is provided a food and beverage that contains the fruit-based food and beverage containing a component derived from amla.

The food and beverage that contains the fruit-based food and beverage containing a component derived from amla of the present invention is produced by adding a fruit-based food and beverage having enhanced richness and full bodiness to a different food and beverage. Thus, there is provided a food and beverage in which astringent taste and the bitter taste are not imparted more than necessary and richness and full bodiness are enhanced.

According to another embodiment of the present invention, there is provided a method for improving a quality of taste in a food and beverage or a method for producing a food and beverage whose quality of taste is improved, comprising adding at least one selected from a group consisting of amla fruit, amla fruit juice and amla fruit extract, and a fruit-based food and beverage to a different food and beverage. In addition, according to another embodiment of the present invention, there is provided a method for improving a quality of taste in a food and beverage or a method for producing a food and beverage whose quality of taste is improved, comprising adding a polyphenol derived from amla fruit and a fruit-based food and beverage to a different food and beverage. In these methods, the component derived from amla used for the present invention and the fruit-based food and beverage may be added to a different food and beverage at the same time or sequentially without mixing them together in advance, followed by mixing the whole. According to these methods, it is possible to easily improve the quality of taste of a food and beverage, since it is not necessary to produce the fruit-based food and beverage containing a component derived from amla of the present invention in advance.

The method and timing for adding the component derived from amla, together with the fruit-based food and beverage, to a food and beverage are not specifically limited. For example, the components derived from amla and the fruit-based food and beverage each may be mixed as a part of the raw material, at the time of producing the food and beverage, during the production of the food and beverage, immediately before taking, or during eating. In addition, the type of the food and beverage is not specifically limited, if the improvement is desired for the quality of taste in the food and beverage.

The respective amounts of the component derived from amla and the fruit-based food and beverage used in the present invention and added to a different food and beverage, are not specifically limited. One of ordinary skill in the art can appropriately select these amounts based on the kinds and properties of the food and beverage.

For example, the amount of the component derived from amla added to a different food and beverage is preferably 3 to 500 ppm, more preferably 10 to 500 ppm, further preferably 10 to 400 ppm, furthermore preferably 20 to 300 ppm, and particularly preferably 30 to 300 ppm, in terms of the concentration converted to that of a polyphenol derived from amla fruit. Alternatively, the amount added is 0.004 to 0.68 vol. %, preferably 0.013 to 0.68 vol. %, more preferably 0.013 to 0.54 vol. %, further preferably 0.026 to 0.41 vol. %, and particularly preferably 0.04 to 0.41 vol. %, in terms of the concentration converted to that of amla fruit extract (for example, the extract of the example 1 described below).

When that the fruit-based food and beverage is grape wine, the amount of grape wine added to the food and beverage is, for example, 0.01 to 80 weight part, preferably 0.03 to 50 weight part, further preferably 0.05 to 50 weight part, and further more preferably 0.1 to 20 weight part relative to 100 weight part of the food and beverage.

The method for improving the quality of taste in the food and beverage and the method for producing the food and beverage whose quality of taste is improved in the present invention may be a method comprising adding the fruit-based food and beverage containing a component derived from amla of the present invention to a different food and beverage.

The amounts of the fruit-based food and beverage containing the component derived from amla of this invention used in these methods and added to a different food and beverage are not specifically limited. One of those skilled in the art can appropriately select these amounts depending on the kinds and properties of the food and beverage.

The method and timing of adding the fruit-based food and beverage containing a component derived from amla of the present invention to a different food and beverage, used for these methods, can be determined according to the method and timing of adding the component derived from amla and the fruit-based food and beverage to a different food and beverage in the present description.

### EXAMPLES

Hereinafter, the present invention will be described more specifically referring to the examples. The technological scope of the present invention is not limited to these examples.

### Example 1

### Sensory Evaluation of Fruit Liquor Containing a Component Derived from Amla Obtained by Adding Amla Fruit Extract

A 20 g portion of amla fruit juice powder (amla juice powder HJK-2896, produced by Inabata Koryo Co., Ltd.) was added to 100 mL of 10 vol. % ethanol, and the solution was mixed with stirring at room temperature (20° C.) for one hour. The liquid mixture obtained was filtered by a filter paper (NA-10M, produced by ADVANTEC), and the filtrate (hereinafter, referred to as “amla extract”) was obtained as an amla fruit juice extract.

The amla extract was added to a fruit liquor (Mercian wine economical red, produced by Mercian Corporation), to have the concentration represented in Table 1 described below, so as to obtain samples (test examples 1 and 2). As comparison samples (comparison examples 1 to 5), a fruit liquor containing no addition, and a fruit liquor in which a catechin extract or a tannin extract instead of the amla extract was added to have the concentration represented in Table 1, were used. It should be noted that the catechin extract and the tannin extract were obtained according to the method similar to that used for producing the amla extract, by extraction using alcohol from catechin powder (Sunphenon 90S, produced by Taiyo Kagaku) and tannin powder (Food additive tannic acid AL, produced by Fuji Chemical Industry Co., Ltd.), and by filtration.

The concentrations of total polyphenol in fruit liquor of the samples obtained and the comparison samples were measured by the Folin-Denis method in which gallic acid was used as for the calibration curve. The results are shown in Table 1.

TABLE 1

| | Companson | Comparison | Comparison | Comparison | Comparison | Test | Test |
|---|---|---|---|---|---|---|---|
| | Example 1 | Example 2 | Example 3 | Example 4 | Example 5 | Example 1 | Example 2 |
| Fruit liquor | 100 | 100 | 100 | 100 | 100 | 100 | 100 |
| Catechin extract | — | 1 | 1.5 | — | — | — | — |
| Tannin extract | — | — | — | 1 | 1.5 | — | — |
| Amla extract | — | — | — | — | — | 1 | 4 |
| Concentrations of total polyphenol | 1000 | 2935 | 3904 | 2900 | 3850 | 1739 | 3957 |
| in fruit liquor (ppm) | | | | | | | |

Unit: Vol./Vol. %, and ppm only for polyphenol concentration

A sensory evaluation was carried out for the samples and comparison samples. The sensory evaluation was carried out by four trained panelists. The “richness and full bodiness” and the “astringent taste and bitter taste” of the fruit liquor were evaluated as described below, and average values of the evaluation were determined.

### (Criteria for Sensory Evaluation)

The “richness and full bodiness” was represented by the strength, and evaluated according to the criteria described below.
3: the richness and full bodiness is felt strong and clear.
2: the richness and full bodiness is felt slightly strong.
1: the richness and full bodiness is felt.
0: the richness and full bodiness is not felt at all.

The “astringent taste and bitter taste” was evaluated according to the criteria described below.

### (Evaluation of Astringent Taste and Bitter Taste)

3: the astringent taste and bitter taste is not felt at all.
2: the astringent taste and bitter taste is felt.
1: the astringent taste and bitter taste is felt slightly strong.
0: the astringent taste and bitter taste is felt strong and clear.

The results (average values) are shown in Table 2.

TABLE 2

| | Comparison | Comparison | Comparison | Comparison | Comparison | Test | Test |
|---|---|---|---|---|---|---|---|
| | Example 1 | Example 2 | Example 3 | Example 4 | Example 5 | Example 1 | Example 2 |
| Richness and full bodiness | 1 | 1 | 0 | 0 | 0 | 2 | 3 |
| Astringent taste and bitter taste | 2 | 2 | 0 | 0 | 0 | 2 | 1 |

As shown in Table 2, the fruit liquor (test examples 1 and 2) obtained by adding the amla extract did not have astringent taste and bitter taste more than necessary, but had strong richness and full bodiness, compared with the fruit liquor (comparison examples 2 and 3) obtained by adding the catechin extraction liquid, with the fruit liquor (comparison examples 4 and 5) obtained by adding the tannin extract and with the fruit liquor (comparison example 1) to which these extracts were not added.

### Example 2

### The Amount Added of Polyphenol Derived from Amla Fruit and Sensory Evaluation of Fruit Liquor

The amla extract obtained in example 1 described above was added to a fruit liquor (Mercian wine economical red, produced by Mercian Corporation) to have the concentrations described in Table 3, so as to obtain the samples (test examples 1 to 6). As the comparison sample (comparison examples 1), an additive-free fruit liquor was used.

The concentrations of total polyphenol in fruit liquor of the samples obtained and the comparison sample were measured by the Folin-Denis method in which gallic acid was used for the calibration curve. In addition, the concentration of polyphenol derived from the added amla extract was calculated.

The results are shown in Table 3.

TABLE 3

| | Comparison | Test | Test | Test | Test | Test |
|---|---|---|---|---|---|---|
| | Example 1 | Example 3 | Example 1 | Example 4 | Example 2 | Example 5 |
| Fruit liquor | 100 | 100 | 100 | 100 | 100 | 100 |
| Amla extract | — | 0.5 | 1 | 2.5 | 4 | 5 |
| Concentrations of polyphenol derived | — | 370 | 739 | 1848 | 2957 | 3696 |
| from amla extract (ppm) | | | | | | |
| Concentrations of total polyphenol | 1000 | 1370 | 1739 | 2848 | 3957 | 4696 |
| in fruit liquor (ppm) | | | | | | |

Unit: Vol./Vol. %, and ppm only for polyphenol concentration

A sensory evaluation was carried out for the samples and the comparison samples, similarly to the example 1 described above. The results (average values) are shown in Table 4.

TABLE 4

| | Comparison | Test | Test | Test | Test | Test |
|---|---|---|---|---|---|---|
| | Example 1 | Example 3 | Example 1 | Example 4 | Example 2 | Example 5 |
| Richness and full bodiness | 1 | 1 | 2 | 3 | 3 | 2 |
| Astringent taste and bitter taste | 2 | 2 | 2 | 2 | 1 | 1 |

As shown in Table 4, the fruit liquor (test examples 1 to 5) obtained by adding the amla extract did not have the astringent taste and bitter taste more than necessary, but had strong richness and full bodiness.

### Example 3

### Food and Beverage

Relative to 100 weight part of patty of hamburg steak, 0.04 weight part of the amla extract (amla fruit juice extract) obtained in example 1 described above and 5 weight part of a fruit liquor (Mercian wine economical red, produced by Mercian Corporation) were added, and the material was broiled to make a hamburg steak. The hamburg steak obtained had improved quality of taste. In addition, this hamburg steak did not have astringent taste and bitter taste, but had increased richness and full bodiness.

### Example 4

### Sensory Evaluation of Fruit-Based Beverage (Wine Taste Beverage) Containing a Component Derived from Amla Obtained by Adding Amla Fruit Extract

The amla extract obtained in example 1 described above was added to a wine taste beverage (Vinzero (red), produced by ALPS Co., Ltd.) to have the concentration described in Table 5, so as to obtain a sample (test example 6). In addition, an additive-free wine taste beverage, and a wine taste beverage to which the catechin extract or the tannin extract obtained in example 1 described above was added were similarly prepared as the comparison samples (comparison examples 6 to 8).

The concentrations of polyphenol in the amla extract, the catechin extract and the tannin extract obtained in the example 1 described above were previously measured in advance by the Folin-Denis method in which gallic acid was used for the calibration curve. Then, the concentrations of total polyphenol in beverage of the sample obtained and the comparison samples were measured. The results are shown in Table 5.

TABLE 5

| | Comparison | Comparison | Comparison | Test |
|---|---|---|---|---|
| | Example 6 | Example 7 | Example 8 | Example 6 |
| wine taste | 100 | 100 | 100 | 100 |
| beverage | | | | |
| Catechin extract | — | 1.5 | — | — |
| Tannin extract | — | — | 1.5 | — |
| Amla extract | — | — | — | 4 |
| Concentrations of | 1100 | 4000 | 3950 | 4050 |
| total polyphenol | | | | |
| in beverage (ppm) | | | | |

Unit: Vol./Vol. %, and ppm only for polyphenol concentration

A sensory evaluation was carried out for the samples and the comparison samples, similarly to example 1 described above. The results (average values) are shown in Table 6.

TABLE 6

| | Comparison | Comparison | Comparison | Test |
|---|---|---|---|---|
| | Example 6 | Example 7 | Example 8 | Example 6 |
| Richness | 1 | 0 | 1 | 3 |
| and | | | | |
| full bodiness | | | | |
| Astringent taste | 3 | 1 | 0 | 2 |
| and | | | | |
| bitter taste | | | | |

As shown in Table 6, the wine taste beverage (test example 6) obtained by adding the amla extract did not have astringent taste and bitter taste more than necessary, but had strong richness and full bodiness, compared with the wine taste beverage (comparison example 7) obtained by adding the catechin extract, with the wine taste beverage (comparison example 8) obtained by adding the tannin extract and with the additive-free wine taste beverage (comparison example 6).

### Example 5

### Sensory Evaluation of Fruit-Based Beverage (Grape Juice) Containing a Component Derived from Amla Obtained by Adding Amla Fruit Extract

The amla extract obtained in example 1 described above was added to a grape juice (Welch GRAPE 100 produced by CALPIS Co., Ltd.) to have the concentration described in Table 7, so as to obtain a sample (test example 7). In addition, additive-free grape juice and grape juice to which the catechin extract or the tannin extract obtained in the example 1 described above was added were similarly prepared as the comparison samples (comparison examples 9 to 11).

Similarly to example 4, the concentrations of total polyphenol in the beverage of the sample obtained and the beverages of comparison samples obtained were measured. The results are shown in Table 7.

TABLE 7

| | Comparison | Comparison | Comparison | Test |
|---|---|---|---|---|
| | Example 9 | Example 10 | Example 11 | Example 7 |
| Grape juice | 100 | 100 | 100 | 100 |
| Catechin | — | 1.5 | — | — |
| extract | | | | |
| Tannin | — | — | 1.5 | — |
| extract | | | | |
| Amla | — | — | — | 4 |
| extract | | | | |
| Concentrations of | 1700 | 4600 | 4550 | 4650 |
| total polyphenol | | | | |
| in beverage (ppm) | | | | |

Unit: Vol./Vol. %, and ppm only for polyphenol concentration

A sensory evaluation was carried out similarly to example 1 described above for the samples and the comparison samples. The results (average values) are shown in Table 8.

TABLE 8

| | Comparison | Comparison | Comparison | Test |
|---|---|---|---|---|
| | Example 9 | Example 10 | Example 11 | Example 7 |
| Richness | 1 | 0 | 1 | 2 |
| and | | | | |
| full bodiness | | | | |
| Astringent taste | 3 | 0 | 0 | 2 |
| and | | | | |
| bitter taste | | | | |

As shown in Table 8, the grape juice (test example 7) obtained by adding the amla extract did not have astringent taste and bitter taste more than necessary, but had strong richness and full bodiness, compared with the grape juice (comparison example 10) obtained by adding the catechin extract, with the grape juice (comparison example 11) obtained by adding the tannin extract and with the additive-free grape juice (comparison example 9).

### Example 6

### Sensory Evaluation of Fruit-Based Beverage (Grapefruit Juice) Containing Components Derived from Amla Obtained by Adding Amla Fruit Extract

The amla extract obtained in example 1 described above was added to a grapefruit juice (Welch Pink Grape fruit100 produced by CALPIS Co., Ltd.) to have the concentration described in Table 9, so as to obtain a sample (test example 8). In addition, additive-free grapefruit juice and grapefruit juice to which the catechin extract or the tannin extract obtained in the example 1 described above was added were similarly prepared as the comparison samples (comparison examples 12 to 14).

TABLE 9

| | Comparison | Comparison | Comparison | Test |
|---|---|---|---|---|
| | Example 12 | Example 13 | Exampe 14 | Example 8 |
| Grapefruit juice | 100 | 100 | 100 | 100 |
| Catechin | — | 1.5 | — | — |
| extract | | | | |
| Tannin | — | — | 1.5 | — |
| extract | | | | |
| Amla | — | — | — | 4 |
| extract | | | | |

Unit: Vol./Vol. %

A sensory evaluation was carried out for the sample and the comparison samples, similarly to the example 1 described above. The results (average values) are as shown in Table 10.

TABLE 10

| | Comparison | Comparison | Comparison | Test |
|---|---|---|---|---|
| | Example 12 | Example 13 | Example 14 | Example 8 |
| Richness | 0 | 0 | 0 | 2 |
| and | | | | |
| full bodiness | | | | |
| Astringent taste | 2 | 1 | 1 | 2 |
| and | | | | |
| bitter taste | | | | |

As shown in Table 10, the grapefruit juice (test example 8) obtained by adding the amla extract did not have the astringent taste and bitter taste more than necessary, but had strong richness and full bodiness, compared with the grapefruit juice (comparison example 13) obtained by adding the catechin extract, with the grapefruit juice (comparison example 14) obtained by adding the tannin extract and with the additive-free grapefruit juice (comparison example 12).

### Example 7

### Sensory Evaluation of Fruit-Based Beverage (Orange Juice) Containing a Component Derived from Amla Obtained by Adding Amla Fruit Extract

The amla extract obtained in example 1 described above was added to orange juice (Dole Orange Juice produced by MEGMILK SNOW BRAND Co., Ltd.) to have the concentration described in Table 11, so as to obtain a sample (test example 9). In addition, an additive-free orange juice and orange juice to which the catechin extract or the tannin extract obtained in example 1 described above was added were similarly prepared as the comparison samples (comparison examples 15 to 17).

TABLE 11

| | Comparison | Comparison | Comparison | Test |
|---|---|---|---|---|
| | Example 15 | Example 16 | Example 17 | Example 9 |
| Orange juice | 100 | 100 | 100 | 100 |
| Catechin extract | — | 1.5 | — | — |
| Tannin extract | — | — | 1.5 | — |
| Amla extract | — | — | — | 4 |

Unit: Vol./Vol. %

A sensory evaluation was carried out for the samples and the comparison samples, similarly to example 1 described above. The results (average values) are as shown in Table 12.

TABLE 12

| | Comparison | Comparison | Comparison | Test |
|---|---|---|---|---|
| | Example 15 | Example 16 | Example 17 | Exampe 9 |
| Richness | 0 | 1 | 1 | 2 |
| and | | | | |
| full bodiness | | | | |
| Astringent taste | 3 | 1 | 1 | 2 |
| and | | | | |
| bitter taste | | | | |

As shown in Table 12, the orange juice (test example 9) obtained by adding the amla extract did not have astringent taste and bitter taste more than necessary, but had strong richness and full bodiness, compared with the orange juice (comparison example 16) obtained by adding the catechin extract, with the orange juice (comparison example 17) obtained by adding the tannin extract and with the additive-free orange juice (comparison example 15).

### Example 8

### Sensory Evaluation of Fruit-Based Beverage Containing a Component Derived from Amla (Apple Juice) Obtained by Adding Amla Fruit Extract

The amla extract obtained in example 1 described above was added to an apple juice (Dole Apple Juice produced by MEGMILK SNOW BRAND Co., Ltd.) to have the concentration described in Table 13, so as to obtain a sample (test example 10). In addition, an additive-free apple juice and apple juice to which the catechin extract or the tannin extract obtained in example 1 described above was added were similarly prepared as the comparison samples (comparison examples 18 to 20).

TABLE 13

| | Comparison | Comparison | Comparison | Test |
|---|---|---|---|---|
| | Example 18 | Example 19 | Example 20 | Example 10 |
| Apple juice | 100 | 100 | 100 | 100 |
| Catechin | — | 1.5 | — | — |
| extract | | | | |
| Tannin extract | — | — | 1.5 | — |
| Amla extract | — | — | — | 4 |

Unit: Vol./Vol. %

A sensory evaluation was carried out for the sample and the comparison samples, similarly to example 1 described above. The results (average values) are as shown in Table 14.

TABLE 14

| | Comparison | Comparison | Comparison | Test |
|---|---|---|---|---|
| | Example 18 | Example 19 | Example 20 | Example 10 |
| Richness | 0 | 1 | 0 | 2 |
| and | | | | |
| full bodiness | | | | |
| Astringent taste | 3 | 0 | 0 | 3 |
| and | | | | |
| bitter taste | | | | |

As shown in Table 14, the apple juice (test example 10) obtained by adding the amla extract did not have astringent taste and bitter taste more than necessary, but had strong richness and full bodiness, compared with the apple juice (comparison example 19) obtained by adding the catechin extract, with the apple juice (comparison example 20) obtained by adding the tannin extract and with the additive-free apple juice (comparison example 18).

### INDUSTRIAL APPLICABILITY

The present invention provides a fruit-based food and beverage having excellent richness and full bodiness, a method for enhancing richness and full bodiness of a fruit-based food and beverage without imparting astringent taste and bitter taste more than necessary, and food and beverage improved in the quality of taste.

1. A fruit-based food and beverage containing a component derived from amla, which comprises at least one selected from a group consisting of amla fruit, amla fruit juice and amla fruit extract.

2. A fruit-based food and beverage, comprising a polyphenol derived from amla fruit.

3. The fruit-based food and beverage according to claim 1, comprising 300 to 5000 ppm of the polyphenol derived from amla fruit.

4. The fruit-based food and beverage according to claim 1, wherein the fruit used for the fruit-based food and beverage is a grape.

5. A method for improving a quality of taste in a fruit-based food and beverage, comprising adding at least one selected from a group consisting of amla fruit, amla fruit juice and amla fruit extract to the fruit-based food and beverage.

6. A method for improving a quality of taste in a fruit-based food and beverage, comprising adding a polyphenol derived from amla fruit to the fruit-based food and beverage.

7. A food and beverage, comprising the fruit-based food and beverage according to claim 1.

8. A method for improving a quality of taste in a food and beverage, comprising adding at least one selected from a group consisting of amla fruit, amla fruit juice and amla fruit extract, and a fruit-based food and beverage to a different food and beverage.

9. A method for improving a quality of taste in a food and beverage, comprising adding a polyphenol derived from amla fruit and a fruit-based food and beverage to a different food and beverage.
